(19) United States
(12) Patent Application Publication
(10) Pub. No.: US 2001/0022416 A1
(43) Pub. Date: Sep. 20, 2001

(54) Manufacturing method for multilayer ceramic device

(75) Inventors: Hideyuki Harada, Omihachiman-shi (JP); Hideaki Nakai, Shiga-ken (JP); Hirofumi Sunahara, Moriyama-shi (JP); Hiroshi Takagi, Otsu-shi (JP)

Correspondence Address: Keating & Bennett LLP, Suite 312, 10400 Eaton Place, Fairfax, VA, 22030, US

(73) Assignee: Murata Manufacturing Co., Ltd., Nagaokakyo-shi (JP)

(21) Appl. No.: 09/750,497

(22) Filed: Dec. 28, 2000

(30) Foreign Application Priority Data
Feb. 21, 2000 (JP) 2000-042202

(51) Int. Cl. C04B 33/32; C04B 33/36; C04B 35/64

(52) U.S. Cl. 264/643; 264/642; 264/618; 264/616; 264/656; 156/89.12; 156/89.16; 156/285

(57) ABSTRACT

A method of manufacturing a multilayer ceramic device includes forming first and second glass-ceramic green sheets from a ceramic material containing glass by laminating the material to form a green sheet laminate having a cavity with an open surface at one surface thereof. Then, shrinkage-suppressing layers which are formed with shrinkage-suppressing inorganic material having a higher sintering temperature than the ceramic material are applied over the surfaces of the green sheet laminate. Thus, a composite laminate is obtained. Then, the composite laminate is pressed in the laminating direction such that the bottom portion of the cavity receives the same amount of pressure as the surrounding region of the cavity via an opening. Then, the composite laminate is fired, and the shrinkage-suppressing layers are removed.

### BACKGROUND OF THE INVENTION

1. Field of the Invention

The present invention relates to methods of manufacturing ceramic devices, and more specifically, relates to a method of manufacturing a multilayer ceramic device having a cavity.

2. Description of the Related Art

There are increasing demands for reducing sizes and weights, for increasing functionality, for improving reliability, and other characteristics of electronic devices. Accordingly, improvement of substrate-mounting technology is also required. A typical way to efficiently improve the substrate-mounting technology is to increase the wiring density on the substrate.

In order to increase wiring density on the substrate, new multilayer ceramic devices are under development. The multilayer ceramic device is manufactured by printing a conductive layer on each of a plurality of ceramic green sheets, laminating the sheets, pressing the sheets, and then sintering the sheets. To increase the wiring density in the multilayer ceramic device without any problems, the dimensions, shape, and other characteristics of the ceramic green sheets and ceramic layers obtained after the sintering must be precisely controlled during the sintering process of a green sheet laminate, which is obtained by laminating the ceramic green sheets.

This is realized by a method disclosed in Japanese Patent No. 2554415. First, the green sheet laminate is obtained by laminating glass-ceramic green sheets, and then shrinkage-suppressing layers containing inorganic material are disposed on both the upper and the lower surfaces of the green sheet laminate. The inorganic material has a higher sintering temperature than the glass-ceramic green sheets. The resulting structure is then pressed and sintered, and then the inorganic material forming the shrinkage-suppressing layers, which is not sintered, is delaminated and removed. In addition, in Japanese Patent No. 2617643, there is also disclosed a method in which pressure is applied to the green sheet laminate from above and below, in the above described processes.

According to the above-described methods, the green sheets do not easily shrink in the principal plane direction, that is, in the X and the Y directions, and therefore the dimensional accuracy of the resulting substrate is increased. Accordingly, the wiring density may be increased with high reliability.

On the other hand, in addition to the above-described demands for high dimensional accuracy, high wiring density, and high reliability, there is another demand to reduce the size, especially the height, of the multilayer ceramic device. To satisfy such a demand, it is effective to form a cavity for receiving electronic components in the multilayer ceramic device.

Methods for manufacturing the multilayer ceramic device having the cavity as described above are disclosed in, for example, Japanese Unexamined Patent Application Publication Nos. 5-167253 and 8-245268.

In Japanese Unexamined Patent Application Publication No. 5-167253, a method of manufacturing the multilayer ceramic device having the cavity is described. According to this method, a green sheet laminate 2 shown in FIG. 3 having a cavity 1 is obtained first by laminating a plurality of glass-ceramic green sheets. Then, the green sheet laminate 2 is put into a mold 4 in a manner such that the green sheet laminate 2 is sandwiched by a shrinkage-suppressing inorganic material 3 from the upper and the lower surfaces. The inorganic material 3 is not sintered at the sintering temperature of the glass-ceramic green sheets. The mold 4 applies pressure to the inorganic material 3 so as to process the inorganic material 3 by pressure forming. Then, the green sheet laminate 2 is fired. After the sintering process, the shrinkage-suppressing inorganic material 3, which is not sintered, is removed. Accordingly, the multilayer ceramic device having the cavity 1 is manufactured under conditions such that the substrate does not easily shrink in the X and the Y directions.

On the other hand, in Japanese Unexamined Patent Application Publication No. 8-245268, another manufacturing method for a multilayer ceramic device having a cavity is described. According to this method, a green sheet laminate 6 shown in FIG. 4 having a cavity 5 is obtained first by laminating a plurality of glass-ceramic green sheets 7. Then, a plurality of shrinkage-suppressing layers 8 containing shrinkage-suppressing inorganic material are disposed in the cavity 5. The shrinkage-suppressing inorganic material has a higher sintering temperature than the glass-ceramic green sheets. Then, a plurality of glass-ceramic green sheets 9 are laminated on the shrinkage-suppressing layers 8, the laminated glass-ceramic green sheets 9 having the same shape and volume as the cavity 5. Then, a plurality of shrinkage-suppressing layers 10 containing the shrinkage-suppressing inorganic material are formed on the upper surface of the green sheet laminate 6. Then, the upper surface of the shrinkage-suppressing layers 10 is flattened. Then, a plurality of shrinkage-suppressing layers 11 are laminated on the bottom surface of the green sheet laminate 6. The resulting structure is then pressed in the laminating direction, and is then fired while being uniformly pressed in the laminating direction. After the sintering process, the shrinkage-suppressing layers 8, 10, and 11, which are not sintered, are removed along with the sintered body of the glass-ceramic green sheets 9. Accordingly, the multilayer ceramic device having the cavity 5 is manufactured under conditions such that the substrate does not easily shrink in the X and the Y directions.

The method described in Japanese Unexamined Patent Application Publication No. 5-167253, however, may encounter the following problems. That is, in the sintering process, the part under the cavity 1 and the other parts in the ceramic green sheets may exhibit different amounts of shrinkage in the thickness direction. More specifically, the amount of shrinkage at the region surrounding the cavity may be larger than that at the bottom portion of the cavity 1. Accordingly, the pressure applied to the green sheet laminate 2 via the inorganic material 3 is concentrated at the bottom portion of the cavity 1, which is the thinnest part of the green sheet laminate 2. As a result, cracking may occur between the cavity 1 and the surrounding region, or the flatness of the bottom surface of the cavity 1 may be degraded.

On the other hand, according to the method described in Japanese Unexamined Patent Application Publication No. 8-245268, the flatness of the bottom surface of the cavity 5 would not be degraded, and deformation at the region surrounding the cavity 5 or cracking do not easily occur. However, there is a problem in that a considerable number of processes are required to obtain the structure as shown in FIG. 4.

### SUMMARY OF THE INVENTION

In order to overcome the problems described above, preferred embodiments of the present invention provide a method of manufacturing a multilayer ceramic device having a cavity.

According to one preferred embodiment of the present invention, a method of manufacturing a multilayer ceramic device includes the steps of preparing a ceramic material containing a glass component, preparing a shrinkage-suppressing inorganic material having a higher sintering temperature than the ceramic material, forming, with the ceramic material, first glass-ceramic green sheets having first openings for forming a cavity and second glass-ceramic green sheets which do not have openings at least at a position where the first openings are provided, laminating the first glass-ceramic green sheets and the second glass-ceramic green sheets to obtain a green sheet laminate having the cavity formed by the first openings, the cavity having an open surface in at least one of the surfaces of the green sheet laminate in the laminating direction, and forming shrinkage-suppressing layers with the shrinkage-suppressing inorganic material on both surfaces of the green sheet laminate in the laminating direction, thereby obtaining a composite laminate in which both surfaces of the green sheet laminate are covered by the shrinkage-suppressing layers, pressing the composite laminate in the laminating direction, and sintering the composite laminate.

To solve the above-described problems, the method of manufacturing a multilayer ceramic device of preferred embodiments of the present invention preferably has the following characteristics.

One of the shrinkage-suppressing layers which is formed over the surface in which the open surface of the cavity is provided is formed so as to have a second opening for exposing the open surface of the cavity at the step of obtaining the composite laminate, and, at the step of pressing the composite laminate, the bottom portion of the cavity is pressed via the second opening while the surrounding region of the cavity is pressed.

Preferably, the second opening has substantially the same shape as the open surface of the cavity.

The second glass-ceramic green sheets may have openings at a position different from the position where the first openings are formed in the first glass-ceramic green sheets. However, the second glass-ceramic sheets are preferably not usually provided with openings.

When the composite laminate is pressed, a pressure is preferably applied to the composite laminate in the laminating direction such that the bottom portion of the cavity receives the same amount of pressure as the surrounding region of the cavity.

In addition, the composite laminate is not pressed in the laminating direction during the step of sintering the composite laminate.

After the step of sintering, the shrinkage-suppressing layers are usually removed.

According to various preferred embodiments of the present invention, a dense multilayer ceramic device having the cavity is provided without applying pressure during the sintering process, and with a relatively small number of processes. In addition, shrinkage in the X and the Y directions is prevented during the sintering process. Furthermore, according to various preferred embodiments of the present invention, the flatness of the bottom portion of the cavity is not degraded, and deformation at the surrounding region of the cavity and cracking are prevented, so that a high-quality multilayer ceramic device is obtained.

In addition, according to various preferred embodiments of the present invention, one of the shrinkage-suppressing layers that is formed over the surface of the green sheet laminate in which the open surface of the cavity is formed, is provided with the opening. When this opening has substantially the same shape as the open surface of the cavity, during the process of pressing the composite laminate in the laminating direction, uniform pressing of the bottom portion of the cavity is easily performed over the entire region. In addition, during the sintering process, the shrinkage-suppressing layer can affect the entire region surrounding the cavity with the restraining force. Accordingly, a high-quality multilayer ceramic device may be more reliably obtained.

In addition, when the composite laminate is pressed in a manner such that the bottom portion of the cavity and the surrounding region of the cavity receive the same amount of pressure, it is possible to apply the uniform pressure on the composite laminate. Accordingly, a multilayer ceramic device with higher quality is provided.

Other features, steps, processes, characteristics, and advantages of the present invention will become more apparent from the detailed description of preferred embodiments with reference to the attached drawings.

### BRIEF DESCRIPTION OF THE DRAWINGS

FIG. 1 is a sectional view schematically showing a composite laminate that is obtained during a manufacturing process of a multilayer ceramic device according to a preferred embodiment of the present invention;

FIG. 2 is a sectional view schematically showing a composite laminate that is obtained during a manufacturing process of a multilayer ceramic device according to another preferred embodiment of the present invention;

FIG. 3 is a sectional view for explaining a conventional manufacturing method for a multilayer ceramic device; and

FIG. 4 is a sectional view for explaining another conventional manufacturing method for a multilayer ceramic device.

### DETAILED DESCRIPTION OF PREFERRED EMBODIMENTS

FIG. 1 is a sectional view schematically showing a composite laminate 12 that is obtained during a process of manufacturing a multilayer ceramic device according to a preferred embodiment of the present invention.

A low-sintering-temperature ceramic material containing a glass component is provided for obtaining the composite laminate 12. In addition, a shrinkage-suppressing inorganic material having a higher sintering temperature than the ceramic material is also provided.

The above-described low-sintering-temperature ceramic material is mixed with an organic component such as binder solvent for obtaining a desired slurry, which is used for forming the first glass-ceramic green sheets 15 and the second glass-ceramic green sheets 16. The first glass-ceramic green sheets 15 have openings 14 which define a cavity 13, and the second glass-ceramic green sheets 16 do not have openings.

A green sheet laminate 17 is obtained by laminating the first glass-ceramic green sheet 15 and the second glass-ceramic green sheets 16. More specifically, the second glass-ceramic green sheets 16 are laminated first, and then the first glass-ceramic green sheets 15 are laminated thereon. Accordingly, the opening 14 defines a cavity 13 having an open surface 20 at one surface 18 of the two surfaces 18 and 19 of the green sheet laminate 17 in the laminating direction.

Although not shown in the figure, the green sheet laminate 17 is provided with internal conductive layers or internal resistors at the boundaries between the surfaces of the glass-ceramic green sheets 15 and 16. In addition, conductive via holes are formed through particular sheets of the glass-ceramic green sheets 15 and 16. The green sheet laminate 17 is also provided with external conductive layers on both surfaces 18 and 19.

In addition, the green sheet laminate 17 is provided with shrinkage-suppressing layers 21 and 22 that are formed with the above-described shrinkage-suppressing inorganic material over surfaces 18 and 19, respectively. The shrinkage-suppressing layer 21, which is formed over the surface 18 in which the open surface 20 of the cavity 13 is formed, is provided with an opening 23 for exposing the open surface 20 of the cavity 13. Preferably, the opening 23 has substantially the same shape as the open surface 20 of the cavity 13.

The shrinkage-suppressing layers 21 and 22 are formed by, for example, the following processes. First, a slurry is adjusted by mixing the shrinkage-suppressing inorganic material and the organic component such as binder solvent. The slurry is formed in the shape of sheets to provide inorganic sheets 24. Then, the inorganic sheets 24 are laminated together with the glass-ceramic green sheets 15 and 16, thus forming the shrinkage-suppressing layers 21 and 22 on the surfaces 18 and 19 of the green sheet laminate 17. Each of the shrinkage-suppressing layers 21 and 22 is preferably formed with a plurality of inorganic sheets 24, so that sufficient thickness is provided.

The shrinkage-suppressing layers 21 and 22 may also be formed by applying the above-described slurry containing the shrinkage-suppressing inorganic material on both of the surfaces 18 and 19 of the green sheet laminate 17.

Accordingly, the composite laminate 12 is obtained in which both surfaces 18 and 19 of the green sheet laminate 17 are covered with the shrinkage-suppressing layers 21 and 22.

Next, the composite laminate 12 is pressed in the laminating direction thereof. During the pressing process, the surrounding region of the cavity 13 is pressed, and the bottom portion of the cavity is also pressed via the opening 23. More specifically, the composite laminate 12 is put into a mold (not shown), and is pressed by a hydrostatic pressing method, a rigid body pressing method, or other suitable method.

The composite laminate 12 is preferably pressed in the laminating direction in a manner such that the bottom portion of the cavity 13 and the surrounding region of the cavity 13 receive the same amount of pressure. Thus, the mold which receives the composite laminate 12 preferably has a structure which is capable of applying the same pressure to the bottom portion of the cavity 13 and the surrounding region of the cavity 13. For example, the mold may be provided with a protrusion which fits the cavity, or a pressing plate having such a protrusion may be applied.

When the above-described hydrostatic pressing method is applied, it is easy to apply the same amount of pressure to the bottom portion of the cavity 13 and the surrounding region of the cavity 13. Accordingly, the hydrostatic pressing method is more preferable than the rigid body pressing method.

In the case of the rigid body pressing method, a pressing apparatus may be used which has a pressing plate constructed such that the same amount of pressure is applied to the bottom portion of the cavity 13 and the surrounding region of the cavity 13. Alternatively, the pressing process may be performed in two steps, with the first step being for pressing the bottom portion of the cavity 13, and the second step for pressing the surrounding region of the cavity 13.

As in the present preferred embodiment, when the shrinkage-suppressing layer 21 is provided with the opening 23 having substantially the same shape as the open surface 20 of the cavity 13, uniform pressing of the bottom portion of the cavity 13 is easily performed over the entire region.

Next, the composite laminate 12 is fired. More specifically, the composite laminate 12 is first degreased so as to decompose and remove the organic components, and then the main sintering process is then performed. A temperature of about 200° C. to about 600° C. is preferably applied during the degreasing process, and a temperature of about 800° C. to about 1000° C. is preferably applied during the main sintering process. During the sintering process, the composite laminate 12 is not pressed in the laminating direction.

The shrinkage-suppressing inorganic material contained in the shrinkage-suppressing layers 21 and 22 is not substantially sintered during the above-described sintering process. Thus, the shrinkage-suppressing layers 21 and 22 do not substantially shrink. Accordingly, the green sheet laminate 17 shrinks only in the thickness direction during the sintering process. The shrinkage-suppressing layers 21 and 22 prevent the green sheet laminate 17 from shrinking in the X and the Y directions.

In addition, both surfaces 18 and 19 of the green sheet laminate 17 are covered by the shrinkage-suppressing layers 21 and 22, and the surrounding region and the bottom portion of the cavity 13 are pressed in advance of the sintering process. Accordingly, flatness of the bottom portion of the cavity 13 is ensured, and deformation of the surrounding region of the cavity and cracking and are prevented.

In addition, according to the present preferred embodiment, the shrinkage-suppressing layer 21 is provided with the opening 23 having substantially the same shape as the open surface 20 of the cavity 13. Accordingly, the shrinkage-suppressing layer 21 completely covers the surrounding region of the cavity 13 so as to affect the entire region surrounding the cavity 13 with the restraining force for shrinkage-suppression during the sintering process. Accordingly, deformation at the surrounding region of the cavity 13 and cracking are more reliably prevented.

Accordingly, the sintering process of the green sheet laminate 17 provides the desired multilayer ceramic device. The shrinkage-suppressing layers 21 and 22 are ordinarily removed after the multilayer ceramic device is obtained.

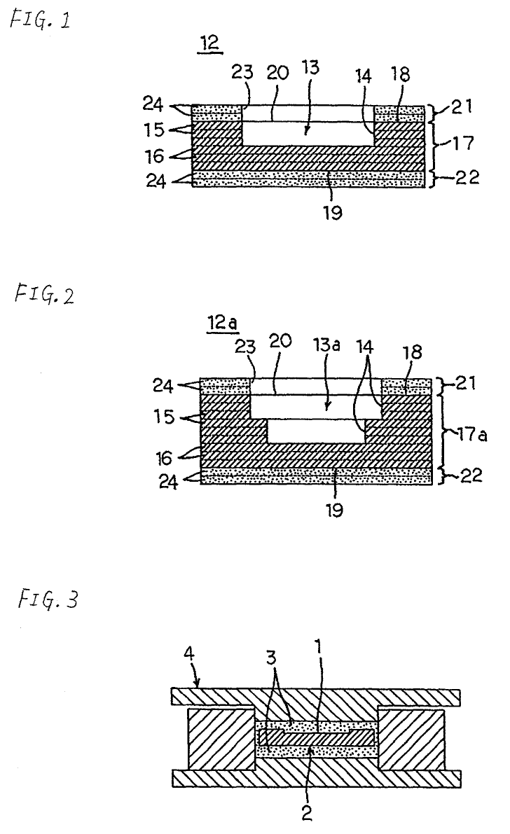

FIG. 2 is a sectional view schematically showing a composite laminate 12a that is obtained during a manufacturing process of a multilayer ceramic device according to another preferred embodiment of the present invention. In FIG. 2, components corresponding to those shown in FIG. 1 are denoted by the same reference numerals, and redundant explanations are omitted.

The composite laminate 12a shown in FIG. 2 is used for obtaining a multilayer ceramic device having a cavity that is provided with a plurality of steps, for example, two steps. Two kinds of first glass-ceramic green sheets 15 having openings 14 of different dimensions are provided, and are laminated to form a green sheet laminate 17a.

According to the preferred embodiments described with reference to FIGS. 1 and 2, the second glass-ceramic green sheets 16 do not have openings. At least some of the second glass-ceramic green sheets 16, however, may have openings at a position which does not correspond to the position where the openings of the first glass-ceramic green sheets 15 are formed.

In a first example of preferred embodiments of the present invention, the composite laminate 12 shown in FIG. 1 was formed, and a multilayer ceramic device was manufactured from the composite laminate 12.

First, the composite laminate 12 having the construction as shown in FIG. 1 was formed. An aluminum powder was used as the shrinkage-suppressing inorganic material contained in shrinkage-suppressing layers 21 and 22.

Next, the entire body of the composite laminate 12 was put into a plastic bag along with a mold, and was vacuum-packed in the plastic bag. The composite laminate 12 that was vacuum-packed along with the mold was then put into a water tank of a hydrostatic pressing apparatus, and was pressed with the pressure of 200 kgf/cm² at a temperature of 60° C.

Next, the composite laminate 12 was removed from the bag and the mold, and then the degreasing process was performed for 4 hours at 450° C. and the main sintering process was performed for 20 minutes at 860° C., during which time the composite laminate 12 was not pressed.

Next, after the sintering process, the shrinkage-suppressing layers 21 and 22 were removed from the composite laminate 12.

Accordingly, the multilayer ceramic device having the cavity 13 was manufactured in such a manner that the substrate does not substantially shrink in the X and the Y directions. In addition, the flatness of the bottom portion of the cavity 13 was not degraded, and deformation at the surrounding region of the cavity 13 and cracking were prevented, so that the cavity 13 was capable of receiving components without problems. The flatness of the bottom portion of the cavity 13 was approximately 20 μm/10 mm as expressed in terms of vertical/horizontal dimensions.

In a Comparative Example 1, a multilayer ceramic device was manufactured by the processes shown in FIG. 3.

First, the green sheet laminate 2 having the cavity 1 was formed from the same ceramic material as the ceramic material used in the above-described example to form the glass-ceramic green sheets 15 and 16.

Next, the green sheet laminate 2 was put into the mold 4 while being sandwiched by an aluminum powder, which served as the shrinkage-suppressing inorganic material 3. The green sheet laminate 2 was then pressed under the same conditions as the above-described example, and was then fired under the same conditions as the above-described example. Then, the shrinkage-suppressing inorganic material 3 was removed.

According to the Comparative Example 1, the pressure was applied via the shrinkage-suppressing inorganic material 3 during the pressing process. In addition, the part under the cavity 1 and the other parts exhibited different amounts of shrinkage. Accordingly, all of the manufactured specimens were deformed at the surrounding region of the cavity 1. In addition, three tenths of the specimens were cracked at the part between the cavity 1 and the surrounding region.

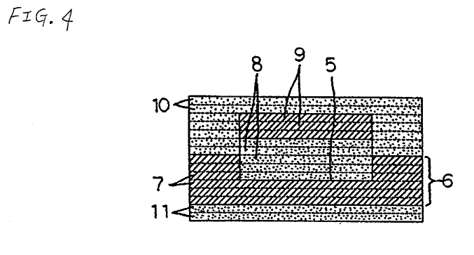

In a Comparative Example 2, a multilayer ceramic device was manufactured by the processes shown in FIG. 4.

With reference to FIG. 4, the glass-ceramic green sheets 7 and 9 having the same composition as that of the glass-ceramic green sheets 15 and 16 used in the above-described example were provided. The shrinkage-suppressing layers 8 and 10 having the same composition as the shrinkage-suppressing layers 21 and 22 used in the example were also provided. Accordingly, the structure shown in FIG. 4 was obtained.

Next, the entire body of this structure was combined by applying a uniform pressure of 200 kgf/cm² at a temperature of 60° C., as in the case of the example.

Next, the structure shown in FIG. 4 was fired under the same conditions as in the case of the example while being pressed with a pressure of 1 kgf/cm² in the laminating direction. Then, the shrinkage-suppressing layers 8, 10, and 11 and the sintered body of the glass-ceramic green sheets 9 were removed.

According to the multilayer ceramic device obtained by the above-described processes, the flatness of the cavity 5 was 20 μm/10 mm as expressed in terms of vertical/horizontal dimensions. In addition, deformation at the surrounding region of the cavity 5 or cracking did not occur.

As described above, the multilayer ceramic device obtained in the Comparative Example 2 had approximately the same quality as that obtained in the example. However, there was a problem in that a considerable number of processes were required to obtain the structure shown in FIG. 4.

While preferred embodiments of the present invention have been described, it is to be understood that modifications and variations will be apparent to those skilled in the art without departing from the spirit of the invention. The scope of the invention, therefore, is to be determined solely by the following claims.

What is claimed is:

1. A method of manufacturing a multilayer ceramic device comprising the steps of:
preparing a ceramic material containing a glass component;
preparing a shrinkage-suppressing inorganic material having a higher sintering temperature than said ceramic material;
forming, with said ceramic material, first glass-ceramic green sheets having first openings for defining a cavity and second glass-ceramic green sheets which do not have openings at least at a position where said first openings are provided;
laminating said first glass-ceramic green sheets and said second glass-ceramic green sheets to obtain a green sheet laminate having said cavity formed by said first openings, said cavity having an open surface in at least one of the surfaces of said green sheet laminate in the laminating direction;
forming shrinkage-suppressing layers with said shrinkage-suppressing inorganic material on both surfaces of said green sheet laminate in the laminating direction, thereby obtaining a composite laminate in which both surfaces of said green sheet laminate are covered by said shrinkage-suppressing layers;
pressing said composite laminate in the laminating direction; and
sintering said composite laminate;
wherein one of said shrinkage-suppressing layers which is formed over the surface in which said open surface of said cavity is provided is formed so as to have a second opening for exposing said open surface of said cavity at the step of obtaining said composite laminate, and at the step of pressing said composite laminate, the bottom portion of said cavity is pressed via said second opening while the surrounding region of the cavity is pressed.

2. The method according to claim 1, wherein said second opening has substantially the same shape as said open surface of said cavity.

3. The method according to claim 2, wherein said second glass-ceramic sheets are not provided with openings.

4. The method according to claim 1, wherein, during the step of pressing said composite laminate, said composite laminate is pressed in the laminating direction in a manner such that the bottom portion of said cavity receives the same amount of pressure as the surrounding region of said cavity.

5. The method according to claim 1, wherein said composite laminate is not pressed in the laminating direction during the step of sintering said composite laminate.

6. The method according to claim 1, further comprising the step of removing said shrinkage-suppressing layers after the step of sintering said composite laminate.

7. The method according to claim 1, further comprising the step of mixing the low-sintering-temperature ceramic material with an organic component for obtaining a desired slurry, and using the slurry to form the first glass-ceramic green sheets and the second glass-ceramic green sheets.

8. The method according to claim 1, further comprising the step of providing internal conductive layers between surfaces of the first and second glass-ceramic green sheets.

9. The method according to claim 1, further comprising the step of providing internal resistors between surfaces of the first and second glass-ceramic green sheets.

10. The method according to claim 1, further comprising the step of mixing the shrinkage-suppressing inorganic material and an organic component to form a slurry and then forming the shrinkage-suppressing layers from the slurry.

11. The method according to claim 10, wherein the shrinkage-suppressing layers are formed by applying the slurry containing the shrinkage-suppressing inorganic material on both major surfaces of the green sheet laminate.

12. The method according to claim 1, wherein the step of pressing the composite laminate is done by one of a hydrostatic pressing method and a rigid body pressing method.

13. The method according to claim 1, wherein the step of pressing is performed such that a bottom portion of the cavity is pressed uniformly over the entire region thereof.

14. The method according to claim 1, wherein the step of sintering said composite laminate includes the step of degreasing the composite laminate.

15. The method according to claim 14, wherein the step of degreasing is performed by subjecting the composite laminate to a temperature of about 200° C. to about 600°C.

16. The method according to claim 1, wherein the step of sintering said composite laminate includes the step of subjecting said composite laminate to a temperature of about 800° C. to about 1000° C.

17. The method according to claim 1, wherein the shrinkage-suppressing inorganic material contained in the shrinkage-suppressing layers is not substantially sintered during the sintering step.

18. The method according to claim 1, wherein the green sheet laminate shrinks only in the thickness direction thereof during the sintering step.

19. The method according to claim 1, wherein shrinkage-suppressing layers prevent the green sheet laminate from shrinking in the X and the Y directions.

20. The method according to claim 1, wherein the cavity has a plurality of steps therein.
